(19) United States
(12) Patent Application Publication
(10) Pub. No.: US 2022/0101375 A1
(43) Pub. Date: Mar. 31, 2022

(54) COMPLEX EVENT PROCESSING FOR CONTEXT-BASED DIGITAL PRESENTATIONS

(71) Applicant: Capital One Services, LLC, McLean, VA (US)

(72) Inventors: Jose MORENO, Berkeley, CA (US); Thomas J. O'CONNOR, San Francisco, CA (US); Richard HIGHTOWER, Dublin, CA (US); Saianirudh KANTABATHINA, Fremont, CA (US); Sathi CHOWDHURY, San Ramon, CA (US); Scott MANDRELL, San Francisco, CA (US); Mary BAUM, San Francisco, CA (US); Selwyn LEHMANN, Antioch, CA (US); Alec SOKOL, San Francisco, CA (US); Patrick RYAN, Santa Clara, CA (US); Forrest THOMAS, Walnut Creek, CA (US); Mitchell ARNETT, McLean, VA (US); Michael QIU, San Francisco, CA (US); Navaneet GALAGALI, Fremont, CA (US); Melissa PANGILINAN, San Francisco, CA (US); Daniel LIU, San Francisco, CA (US); Christopher CELLUCCI, Campbell, CA (US)

(73) Assignee: Capital One Services, LLC, McLean, VA (US)

(21) Appl. No.: 17/035,446

(22) Filed: Sep. 28, 2020

(51) Int. Cl. G06Q 30/02

(52) U.S. Cl. CPC G06Q 30/0254

(57) ABSTRACT

Systems and methods are disclosed herein for providing contextually relevant incentives in real-time to consumers. In one example, the method may include receiving, from a data repository, one or more raw data streams of real time data and determining an identity of the end user based on the one or more raw data streams. The method may further include filtering, using contextual filtering parameters, the received one or more raw data streams to produce filtered data. The method may also include applying a set of rules correlating the filtered data with incentive programs relevant to the filtered data to generate correlated data, and querying the data repository for historical data associated with the end user. The method may also include calculating a propensity score of the end user, and ranking the correlated data. The method may also include sending one or more incentives based on the correlated data ranking.

### BACKGROUND

Rewards programs for transaction cards, such as bonus points, cash back, travel miles, etc. may be earned in many ways. For example, a user may earn points per dollars spent on all purchases, and some companies may offer more points based on the category of the purchase. That is, some companies may reward certain categories of spending (e.g., restaurants, entertainment, etc.). In some programs, the categories that receive the extra points are pre-established by the card provider. However, these reward categories fail to consider the specific habits, interests, or goals of each individual user. Additionally, existing systems fail to provide users such rewards in real-time while processing user-related data.

### BRIEF DESCRIPTION OF THE DRAWINGS

FIG. 1 is a simplified block diagram of a distributed computer network incorporating a specific embodiment of a system for distributed monitoring, evaluation, and response for multiple devices, user accounts, user data, sensor data, and the like, using described event processing techniques, according to some embodiments;

FIG. 2 is a system diagram of a distributed computer network using the described event processing techniques, according to some embodiments;

FIG. 3 is a system diagram of a distributed computer network data flow using the described event processing techniques, according to some embodiments;

FIG. 4 illustrates a computer system that carries out the event processing techniques, according to some embodiments;

FIG. 5 is a flowchart representing an event processing technique, according to some embodiments; and

FIG. 6 is a flowchart representing an event processing technique, according to some embodiments.

### DETAILED DESCRIPTION

To solve the existing problems in the art, embodiments of the present disclosure deploy improved systems, methods, and technology platforms for generating, processing, storing, managing, and delivering digital offerings and for enhancing and customizing the digital offer experience of consumers. Moreover, embodiments of the present disclosure deploy improved system, methods, and technology platforms for improving the ability of offer providers, offer distributors, and retailers to customize digital offer selection, delivery, utilization, management, monetization, and redemption, and for otherwise increasing the efficiency and financial return of the digital offer industry and market.

Examples of applications for the below methods, media, and systems are numerous, but a few are given here merely to indicate possible uses. Other applications will be readily apparent to one of skill in the relevant arts and are likewise contemplated by this disclosure. Moreover, description of “an embodiment” or “one embodiment” should not be construed as limiting the scope of the disclosure, as elements, sub-elements and features of a given embodiment may also be used in other embodiments of the disclosure. While methods described herein may have steps described in a specified order, it will be understood that some of those steps may be re-arranged or performed in a different order. Additionally, embodiments may be given describing applications to particular industries or commercial fields, but scope of the disclosure is not so limited.

Descriptions are given with reference to the figures included herein. When possible and for clarity, reference numbers are kept consistent from figure to figure. Some of the figures are simplified diagrams, which are not to be interpreted as drawn to scale or spatially limiting for the described embodiments. Where appropriate, the particular perspective or orientation of a figure will be given to increase understanding of the depicted features.

According to some embodiments, targeted marketing techniques assist a variety of entities, such as product manufacturers, service providers, and retailers, in efficiently persuading consumers to purchase certain products and service. A marketing entity may include, without limitation, product manufacturers, service providers, retailers, third-party marketing firms acting on behalf of another entity, non-profit organizations, and so forth. The marketing entity may identify characteristics of people (or profiles/devices) to which the entity wishes to “market” a product or service. For example, an entity that sells a particular product X may determine that it wants to market to persons that have purchased a complimentary product Y within a timeframe of Z. Of course, one problem with targeted marketing is that it is sometimes difficult to ascertain exactly what characteristics to target.

Once targeted characteristics have been identified, the entity may then attempt to “market” to persons who have those characteristics. Unfortunately, it is also generally difficult to ascertain whether a given person actually has the targeted characteristics and/or how to actually reach specific persons that have those specific characteristics. For example, a particular retailer may have no idea that a potential consumer recently purchased product Y from another store, and thus be unable to specifically target marketing for Product X to that potential consumer. Large-scale targeted marketing is therefore typically difficult to achieve with a high degree of efficiency. Rather, a marketing entity is typically limited to less efficient targeting techniques, such as targeting specific zip codes or web sites, thus resulting in the marketing entity wasting marketing resources on many persons who do not have the targeted characteristics.

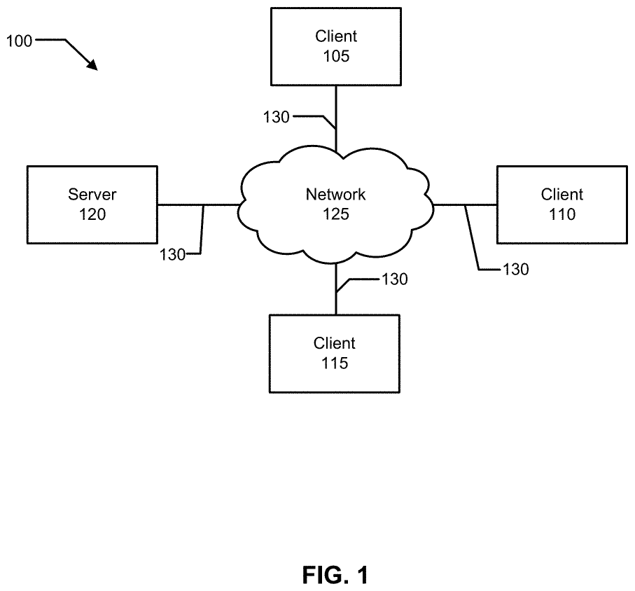

FIG. 1 is a simplified block diagram of a distributed computer network 100 of a system for monitoring, evaluating, and responding to multiple devices, user accounts, user data, sensor data, and the like, using the below-described event processing data stream consumer techniques, according to some embodiments. Computer network 100 may include a number of client systems 105 and 110, a database 115, and a server system 120 coupled to a communication network 125 via a plurality of communication links 130. Communication network 125 provides a mechanism for allowing the various components of distributed network 100 to communicate and exchange information with each other.

Communication network 125 may itself be comprised of many interconnected computer systems and communication links. Communication links 130 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, Internet telephony, IP telephony, digital voice, voice over broadband (VoBB), broadband telephony, Voice over IP (VoIP), public switched telephone network (PSTN), and others. While in one embodiment, communication network 125 is the Internet, in other embodiments, communication network 125 may be any suitable communication network including a local area network (LAN), a wide area network (WAN), a wireless network, an intranet, a private network, a public network, a switched network, and combinations of these, and the like.

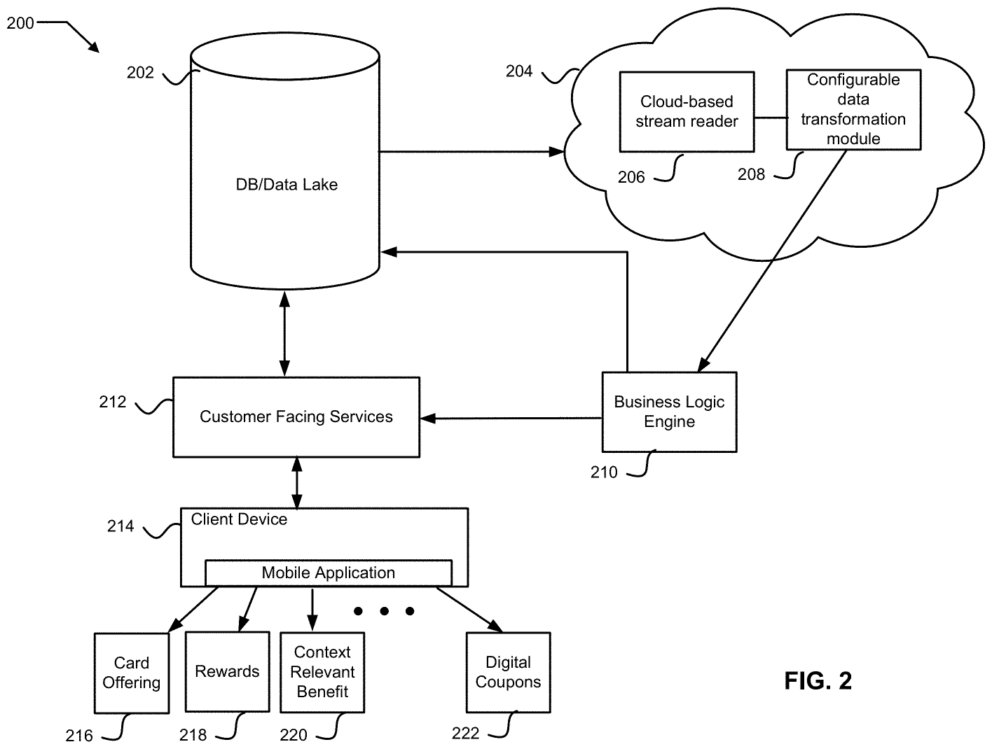

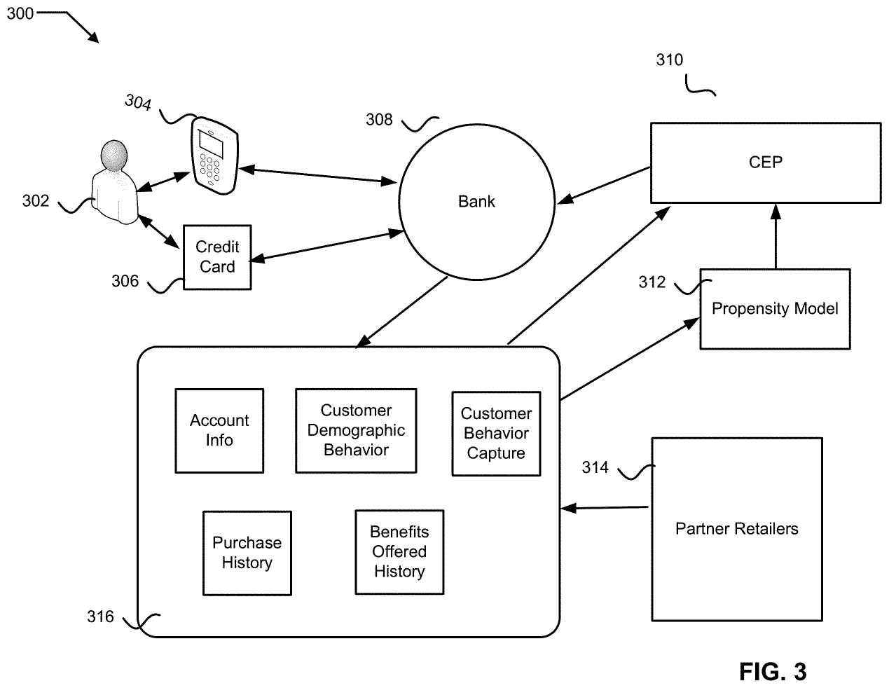

Distributed computer network 100 in FIG. 1 is merely illustrative of an embodiment and does not limit the scope of the systems and methods as recited in the claims. One of ordinary skill in the art would recognize other variations, modifications, and alternatives. For example, more than one server system 120 may be connected to communication network 125. As another example, a number of client systems 105, and 110 may be coupled to communication network 125 via an access provider (not shown) or via some other server system. Additional implementations of computer network 100 may further be illustrated in FIGS. 2 and 3 described herein.

According to one embodiment, a marketing technique may involve incentivizing customer behavior through targeted promotional offers or monitoring a customer behavior (through monitoring use of financial instruments like credit cards, and/or mobile devices associated with the user, or user accounts, and the like). An “offer” may be construed to be a promise by an offer provider, which may be any entity engaged in targeted marketing, to provide a consumer with a benefit under a certain set of implicit or explicit conditions known as terms. An offer may also be a reward offered or earned based on certain attributes of a user (e.g., a user associated with one of client devices 105, 110, or 115). Example benefits may include, without limitation, a monetary gift, a discount applied to the purchase of one or more products or services, free products and/or services, access to additional offers, and so forth. Example terms may include any one or more of, without limitation, actions that the consumer must perform, a specific set of item(s) that must be purchased by the consumer, a specific amount of money that must be spent by the consumer, a timeframe during which the offer is valid, and so forth. A customer benefit of an offer is realized during a process sometimes called “redemption,” which typically takes place during a transaction between the consumer and a retailer. When the consumer wishes to engage in a transaction the retailer determines whether the conditions of the offer have been met. If so, the retailer, which may be any merchant or other entity that sells products or services, provides the benefit to the consumer on behalf of the offer provider.

In some embodiments, the retailer is in fact the offer provider. In other embodiments, the retailer may then seek compensation for providing the benefit from the offer provider by means of a process known as clearing. During the clearing process, the retailer provides evidence to a third-party clearinghouse, or directly to the offer provider, that the retailer provided the benefit. Assuming the evidence is sufficient, the third-party clearinghouse, or offer provider, provides compensation to the retailer. In embodiments involving a third-party clearinghouse, the offer provider may provide the third-party clearinghouse with funds in advance. The offer provider also sends to the third-party clearinghouse funds from which the compensation is provided, or reimburses the third-party clearinghouse for providing the compensation.

According to some aspects, the rewards offered by a retailer may include coupons. According to some embodiments, distribution techniques involve creating digital coupons. One such technique involves creating unique digital coupons that are saved to an account associated with the consumer, such as a store loyalty account. The consumer may redeem such digital coupons during online or physical transactions by presenting an account identifier, such as a store loyalty card or an oral identification of the consumer's telephone number, for the associated account. The consumer may also redeem the digital coupons automatically by presenting the associated credit card. Since many consumer accounts are tied to card-based identifiers, such as store loyalty cards or credit cards, the process of storing a digital coupon identifier to an account may also be referred to as saving a coupon to a card.

Another digital coupon-based technique involves creating unique digital coupons that may be stored on a computing device. The digital coupons may be transmitted from the computing device to a point-of-sale during a transaction using any of a variety of mechanisms. For example, information about the digital coupon may be uploaded to the point-of-sale during an online transaction involving the computing device. As another example, information about the digital coupon may be transmitted wirelessly from a smartphone to a receiving component coupled to a checkout register during a transaction at a brick-and-mortar store.

According to some aspects, based on the information required to generate a reward, and the ways a reward is provided, client systems 105, 110, and 115 may request information from a server system 120, or server system 120 requests and/or tracks information generated that is associated with client systems 105, 110 and/or 115.

Client systems 105/110 enable users/data scientists to access and query information or applications stored by server system 120. A client system may be a computing device. Some example client systems include desktop computers, portable electronic devices (e.g., mobile communications devices, smartphones, tablet computers, laptops) such as the Samsung Galaxy Tab®, Google Nexus devices, Amazon Kindle®, Kindle Fire®, Apple iPhone®, the Apple iPad®, Microsoft Surface®, the Palm Pre™, or any device running the Apple iOS™, Android™ OS, Google Chrome OS, Symbian OS®, Windows Mobile® OS, Windows Phone, BlackBerry OS, Embedded Linux, webOS, Palm OS® or Palm Web OS™.

In a specific embodiment, a “web browser” application executing on a client system enables users to select, access, retrieve, or query information and/or applications stored by server system 120. Examples of web browsers include the Android browser provided by Google, the Safari® browser provided by Apple, Amazon Silk® provided by Amazon, the Opera Web browser provided by Opera Software, the BlackBerry® browser provided by Research In Motion, the Internet Explorer® and Internet Explorer Mobile browsers provided by Microsoft Corporation, the Firefox® and Firefox for Mobile browsers provided by Mozilla®, and others (e.g., Google Chrome).

In another embodiment, server system 120 may also monitor the activities of client systems 105/110 and identify security breaches or alerts that are triggered by irregular activities or activities tracked and sent to the server by network monitoring devices (not shown), or identify instances of fraud, identify theft, and other financial crime activities, or monitor financial transactions, location based services, and the like, in order to generate the appropriate reward or alert.

FIG. 2 is a system diagram of a distributed computer network 200 using the described event processing techniques, according to some embodiments. According to some aspects, computer network 200 may utilize complex event processing (CEP) data stream consumers which draw from user-generated events and interactions, while also taking into account historical purchase patterns to build an improved profile for the customer as will be further described herein. The implementation of CEP allows network 200 (e.g., via server 120) to offer better benefits (e.g., rewards, offers, coupons, and the like) and relevant branded card offers in real-time. Such offers may take into account a user's immediate activity and providing the user with rewards/incentives that take into account the immediate activity. According to some aspects, computer network 200 may include cloud-based infrastructure for scalability and resiliency, while maintaining some degree of in-memory processing for added computational efficiency, as will be further described herein.

According to some aspects, the combination of CEP along with a probabilistic model that relies on propensity-to-purchase parameters, which draws from historical data enables the aggregation of user/consumer data, processing, and generation of tailored rewards, incentive programs, offers, and alerts in real-time. Moreover, the combination of cloud computing and local in-memory logic provides solutions that have increased flexibility and cost-efficiency.

According to some aspects, parallel processing may take place between a client device (e.g., client device 105) and a server (e.g., server 120) in order to provide the most up-to-date information and relevant rewards. For example, client device 105 may host a plurality of applications, including, but not limited to, a payment application. According to some aspects, client device 105 performs calculations using information relevant to the client device, e.g., GPS data, user browsing history, search history, and other information related to activities performed on the device itself. This can eliminate the need to encrypt the data and sending it to a server for processing. Moreover, such parallel processing, as will be further described herein, expedites the processing on the server side, and enables a server to provide more relevant information in real-time.

According to some aspects, client device 105 may be performing in-memory processing which allows for efficient processing and improved relevancy of data that is shared with server 120. Here, for example, client device 105 may poll GPS data for a predetermined amount of time (e.g., 5 minutes, 10 minutes, or even on a constant basis) to determine in what direction the user is walking to in a commercial area (e.g., a mall or the like). In one aspect, while this computation happens on the client-side, a parallel computation is triggered by client 105 to be performed on server 120, in anticipation of the client-side calculation to finish and be sent back to server 120. At this point, server 120 would have retrieved other relevant information from data consumer engines related to the user (e.g., historical data, where the user has been, recent purchases, credit limitations, purchasing habits, and the like.)

According to some embodiments of the present disclosure, tailored systems and reward solutions may be implemented within a retail bank context, which can leverage retail-store partner card purchase history, demographic-specific spending data, real-time mobile banking, and real-time location and context-specific cues to provide real-time solutions for customers.

According to some aspects, a consumer bank may collaborate with a specific retail entity to offer branded credit cards that appeal to users with very specific interests. Both retail entity, consumer bank, and card providers have an interest in maximizing usage of those cards by offering their customers specific and context-relevant rewards. By combining historical purchase patterns from multiple retail partner cards, generalized real-time location, comparable demographic specific accounts, and other real-time events, system 200 may build a more accurate, faster, and computationally efficient propensity-to-buy profile for a customer, and in turn, offer better, context-relevant rewards and offers.

By ingesting internal and external data streams into a cloud-based system, computation can be parallelized, and resiliency in multiple regions can be maintained, while continuously applying business logic in real-time. Streams and historical data from multiple card partners and/or data sources may be aggregated and considered concurrently, in real-time. Moreover, the system may be adapted and customized more quickly than other systems to expand or completely change the business logic behind card offers, spot discounts, and other rewards.

According to some embodiments, system 200 may include data repository 202, cloud infrastructure 204, business logic engine 210 and customer facing services engine 212. System 200 may further include a client device 214 (e.g., client device 105) and may be configured to operate a mobile application that can provide a plurality of offerings. Such offerings may include, but are not limited to, card offerings 216, rewards 218, context-relevant benefits 220, and digital coupons 222.

According to some aspects, data repository 202 may be a database or a data lake. One example of a data lake may be a centralized repository that allows for storing of structured and unstructured data at any scale. Data repository 202 may also be referred to as data lake 202 interchangeably herein. Data lake 202 may also allow for the storage of collected data in an as-is format, without having to first structure the data. Data lake 202 may also allow for the execution of different types of analytics, from dashboards and visualizations to big data processing, real-time analytics, and machine learning. In one embodiment, data lake 202 may ingest non-relational and relational data from Internet of Things (IoT) devices, web sites, mobile applications, social media, and corporate applications. According to some aspects, data lake 202 may also ingest data calculations from client device 214 (e.g., tolled GPS location and the like) that can be sent to server 120 to expedite processing and offering provided by server 120. It can be understood that client device 214 can transmit the parallel processed data to data lake 202 for sharing with server 120, and/or can transmit the parallel processed data directly to server 120.

According to some embodiments, data lake 202 may collect data from internal services (e.g., internal to an organization) or external services (e.g., third part organizations providing data like global positioning system (GPS) data and the like). Upon collection of consumer data, data lake 202 may provide the collected data to cloud systems 204. According to some aspects, cloud systems 204 may include a cloud-based stream reader 206 and a configurable data transformation module 208. One advantage of having cloud-based stream reader 206 and the configurable data transformation module 208 be cloud-based is for improved scalability. For example, cloud systems 204 can be configured to be remote and or receive data from one or more data lakes that track and collect user data.

According to some aspects, cloud-based stream reader 206 may be set to interface with data lake 202 and manage requests and processing of data. Configurable data transformation module 208 may perform a variety of data transformation tasks in order to harmonize the received data. These may include, but are not limited to joining datasets, changing column names, format manipulations, filtering, and machine learning type transformations, including normalization, binning, grouping, and inference of missing values.

According to some embodiments, once the data is transformed according to certain configurations by an entity (e.g. a bank, retailer or the like), the data is then transmitted to business logic engine 210. In one example, business logic engine 210 may be a software and/or hardware system that executes one or more business rules in a runtime production environment. The rules may come from legal regulation (e.g., an employee can be fired for any reason or no reason, but not for an illegal reason), company policy (e.g., all customers that spend more than $100 at one time will receive a 10% discount), or other sources.

Business logic engine 210 may apply rules specific to extracting and contextualizing user data that is ultimately retrieved from data lake 202. In another example, business logic engine 210 may apply rules specific to user purchases. For example, business logic engine 210 may apply rules that would extract data pertaining to restaurant purchases, while ignoring/discard or not considering other purchases, such as sporting activities, grocery purchases, automotive, travel, and the like.

According to some aspects, business logic engine 210 may apply rules relating to credit card fraud detection. It can be appreciated that business logic engine 210 can apply a variety of other rules, including, but not limited to, rules relating to credit card use, purchaser habits, and the like. In one example, a credit card fraud detection rule may be to check how many miles from a customer's home the card was used. For example, if the card was used at a location that is a certain number of miles away from the customer's home (e.g., 200 miles), then this may be an indicator of fraud.

According to some aspects of the present disclosure, business logic engine 210 is updated to account for real-time events, since a CEP engine relies on real-time data. For example, if a customer is on a road trip and is gradually using their card at different stores along the road the customer is traveling on, business logic is updated/modified not to mark the transaction occurring after 200 miles, for example, as a fraudulent transaction. Accordingly, business logic engine 210 updates its rules based on data received from the user. In this example, the business logic rule of “if the transaction occurs >200 miles from the user's home” evolves to become “if the latest transaction occurs >200 miles away from the prior transaction.” This can be further enhanced with threshold adjustments through questions posed to the user over mobile application. For example, the user can be prompted to answer a question like “a suspicious transaction occurred in x at time y. Was this you?”

Upon contextualizing the data, in real-time at business logic engine 210, the data is then transmitted to two different entities for processing. In one aspect, the processed data is fed back to data lake 202. This feedback is beneficial for the following reasons. Initially, feeding the processed data back to data lake 202 allows data lake 202 to become a repository for processed data that can be readily available for consumption by other applications. In this regard, other applications that need to consume processed data can be readily available for other applications that either do not have access to configurable data transformation module 208, or alternatively, do not wish to burden configurable data transformation module 208 by performing a redundant operation it has already performed. Accordingly, this serves to expedite data access, reduces systematic computational costs, and increases the system bandwidth to generate other transformation operations and other data processed by business logic engine.

Another benefit of feeding back processed data to data lake 202 is that it can then serve as historical data associated with the user/consumer/account, etc., that can be fed into customer facing services 212. Customer facing services 212 accordingly can receive historical data (previously processed data) to augment real-time processed data received from business logic engine 210. According to some embodiments, customer facing services 212 may be comprised of micro applications that can provide services without downloading on a client device. Customer facing services 212 may also run on a server, e.g. server system 120, and may be incorporated within a cloud-based system, e.g., cloud systems 204.

According to some embodiments, customer facing services 212 may alternatively be integrated within data lake 202. According to some aspects, customer facing services 212 aggregates processed real-time data from business logic engine 210 and historical data from data lake 202 to generate one or more incentives, offers, rewards, and the like to a customer. These generated incentives may be sent to a client device via a mobile application, or may be retrieved by the client device via the mobile application, or accessing a website, and the like that may be supported by the micro applications. According to some examples, client device 214 may receive card offerings 216, rewards 218, context relevant benefits 220, and/or digital coupons 222.

According to some aspects, an example of a digital coupon-based technique may involve creating unique digital coupons that may be stored on a computing device. The digital coupons may be transmitted from the computing device to a point-of-sale during a transaction using any of a variety of mechanisms. For example, information about the digital coupon may be uploaded to the point-of-sale during an online transaction involving the computing device. As another example, information about the digital coupon may be transmitted wirelessly from a smartphone to a receiving component coupled to a checkout register during a transaction at a brick-and-mortar store.

According to some embodiments, customer facing services 212 may access historical data relating to restaurants a consumer has visited within the past 3 months (or any other per-determined period). Such historical data may also include related attributes, such as time of day the restaurant was visited, location, expenditures, and the like. According to one example, upon receiving real-time processed data from business logic engine pertaining to the consumer's location or restaurant the consumer is dining in, system 200 may provide an incentive, offer, reward, etc., pertaining to this dining experience. For example, if a consumer is dining in restaurant X, or consumer facing services 212 receive real-time data about the consumer's geolocation being in or around the vicinity of restaurant X, consumer facing services 212 may query data lake 202 for historical data relating to consumer's activities associated with restaurant X. Accordingly, if it is determined that the consumer is a regular customer, then the consumer may be provided with an reward (e.g. 10% customer loyalty discount or the like). Such reward may be provided to the consumer via a mobile application on client device 214 through push-notification services or the like.

In some embodiments, customer facing services 212 may be configured to output or deliver the one or more rewards (determined by business logic engine 210) based on a machine learning model trained to determine different incentives associated with respective categories of purchases related to one or more objectives. In some embodiments, the machine learning model may be trained using a supervised machine learning algorithm, an unsupervised machine learning algorithm, or a combination of both, to analyze one or more purchase histories to identify different categories of purchases. The one or more purchase histories may include a purchase history of the user and/or purchase histories of a plurality of users. For example, the machine learning model may be trained using a density-based clustering technique such as, but not limited to, a K-means clustering algorithm or a support-vector clustering algorithm, to cluster the transactions of the purchase history of the user or the purchase histories of a plurality of users into the different categories of purchases.

Based on the clustered transactions, the machine learning model may be trained to associate the categories of purchases (e.g., dining purchases) with the one or more objectives. For example, the machine learning model may be trained using an association algorithm, such as, but not limited to, an apriori algorithm, ECLAT algorithm, or a frequent-pattern growth (FP-growth) algorithm to determine a correlation between the different categories of purchases and the one or more objectives. As one example, the machine learning model may be trained to associate purchases such as recreational or sports retailers, health food stores, facility memberships, or the like with the objective of improving health and fitness. As another example, the machine learning model may be trained to associate purchases such as arts and crafts retailers, book retailers, or the like with increasing artistic hobbies.

In some embodiments, the machine learning model may be further trained to determine a value for each of the one or more incentives. For example, the machine learning model may be trained using a regression algorithm to determine the value for each the one or more incentives. Namely, in some embodiments, the machine learning model may be trained using the purchase history of the user or the purchase histories of the plurality of users, such that the value of each incentive is inversely proportional to a popularity of the category of purchase. For example, if the consumer (or large number of the plurality of consumers, e.g., more than 75%) frequently makes purchases within a category, such as recreational or sports retailers, health food stores, facility memberships, or the like, the machine learning model may be trained to determine a lower value for the incentive. Conversely, if the consumer (or a lower number of consumers of the plurality of consumers, e.g., less than 25%) makes fewer purchases in another category, e.g., artistic hobbies or the like, the machine learning model may be trained to determine a greater value for the incentive. The machine learning model may predict future rewards based on the incentives identified for the user and the purchase history of the user as a propensity model, as will be further described herein.

According to some embodiments, the machine learning model may be implemented as an initial step to generate one or more broad generalizations about the behavior of the customer. For example, the machine learning model may determine that a particular customer often visits a sporting goods store in a particular shopping area. Then the machine learning model may also determine that the particular customer may prefer to also visit a health and wellness store in the same shopping area based on their prior visits to the sporting goods store. This may constitute a broad generalization generated about the customer. Based on the broad generalization, a more specific service may then be provided to the customer. For example, a specific offer associated with the health and wellness store may be presented to the user based on the user's recent visits to the sporting goods store and present location in the shopping area. This may be a function of the business logic engine providing personalized offers. It can be appreciated that one or more machine learning models may be implemented by business logic engine 210. The results of the one or more machine learning models may be stored in data lake 202 and retrieved later as historical data.

FIG. 3 is a system diagram of a distributed computer network data flow using the described event processing techniques, according to some embodiments. According to some aspects, a consumer/user 302 may be utilizing a mobile application (on mobile device 304) associated with a retail bank 308 or using a credit card 306 associated with retail bank 308. In one example, retail bank 308 may capture this transaction data (including geo location data of device 304 and the like) and transmits it to data lake 202. In other words, retail bank 308 may also be a data aggregator/data source that provides data lake 202 with customer related data. Such data, provided by retail bank 308 or other sources, may include real-time data and historical data relating to (but not limited to) consumer account information, customer demographic behavior, customer behavior capture, purchase history, benefits offered history, and the like.

According to some embodiments, account information may be historical information pertaining to the consumer's account. This may be cash flow related information, balances, and the like. This may also include recent purchases, purchase trends and the like. The customer demographic behavior may include historical and real-time data pertaining to behavior data like purchasing habits, and the like, pertaining to consumers within the same demographic (e.g., gender or age, or the like). Customer behavior capture includes real-time and historical data pertaining to customer 302 behavior capture, including information relating to purchases, events, location captures, habits and the like. Purchase history considers historical data pertaining to the consumer's captured history. Benefits offered history relates to previously offered benefits. This may be informative to determine what benefits were previously provided, and how were they leveraged by the consumer.

According to some embodiments, partner retailers 314 may also provide additional information that may be considered as branded customer behavior capture. This may be relevant in that partner retailers may receive additional focus when it is time to provide a recommendation to the consumer 302 as will be further discussed herein.

According to some embodiments, the aggregated data 316 may be provided to propensity model 312 as historical data, and may be provided to complex event processing engine (CEP) 310 as real-time data. In some aspects, CEP 310 may be a system comparable to system 200 that can aggregate data, and generate recommendations/rewards/incentives to a retailer to provide to a consumer. Accordingly, CEP 310 may aggregate real-time user data, and historical data that has been processed by propensity model 312 to generate contextual rewards based on consumer behavior, in real time. Propensity model 312 may be a machine learning model similar to the machine learning model described herein. According to some aspects, an initial baseline for the propensity model can be a generalized model for the customer demographic to which the customer belongs. This model is then updated over time based on the individual customer's behavior. The propensity model may be, for example, a set of probabilities that can answer in the case of a reward offering use-case, “how likely is this specific customer to use this offered discount?” The processing described herein improves the reward generating process in a myriad of ways relating to real-time offering, decisioning that is influenced by real-time data, and generating rewards that are more likely to be used by the customer. This reduces clutter in the reward generating and offering process. For example, the user would not (a) get irrelevant rewards, and (b) would not get rewards that the user is not likely to utilize. This reduces system computation (e.g., mass generation of rewards), and vastly improves customer experience because a customer would not have to be inundated with rewards that are irrelevant or unlikely to be used.

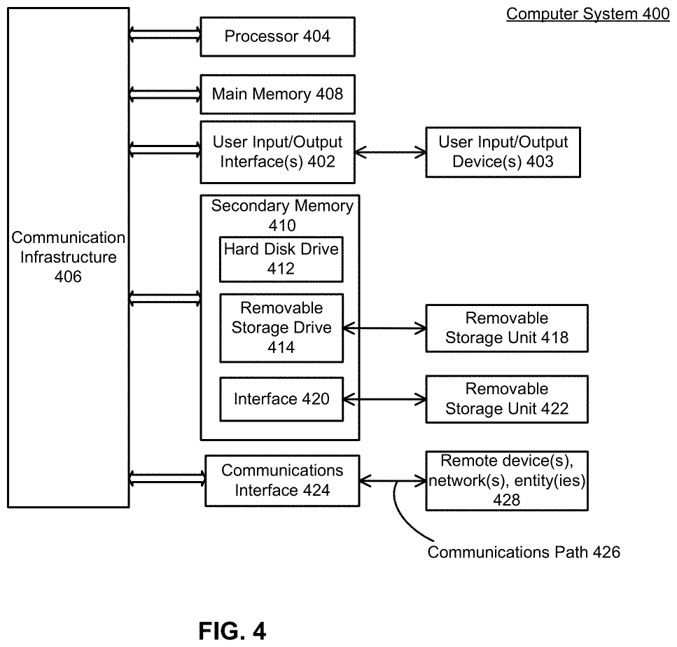

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 606 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random-access memory (RAM). Main memory 608 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system embodiments other than those described herein.

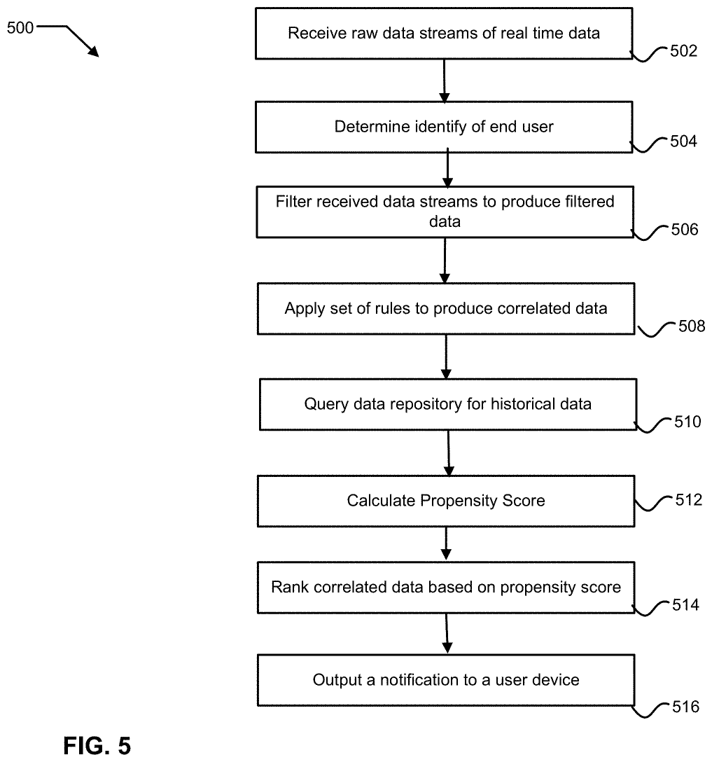

FIG. 5 is a flowchart representing an event processing method 500, according to some embodiments. According to some embodiments, method 500 may be a method for transmitting notifications to an end user (e.g., consumer 302 via client device 105) from a server (e.g., server 120, customer facing services 212, or the like). Method 500 may include receiving, from a data repository (e.g., data lake 202), one or more raw data streams of real time data in response to a query transmitted to the data repository from a data stream consumer application running on the server, the query requesting predetermined real-time data associated with the end user, as illustrated in step 502. Data stream consumer application may be running on data lake 202, may be running on server 120, or may be running independently under the control of either data lake 202 or server 120. According to some aspects, method 500 may further include determining an identity of the end user based on the one or more raw data streams, as illustrated in step 504. In this regard, an identity of the user may be determined based on the generated data, or upon receipt of a request to aggregate data associated with the user.

Method 500 may further include filtering, using contextual filtering parameters, the received one or more raw data streams to produce filtered data, as illustrated in step 506. Such filtering may be performed at least at configurable data transformation module 208. Moreover, method 500 may further include applying a set of rules correlating the filtered data with incentive programs relevant to the filtered data to generate correlated data, as illustrated in step 508. As previously described, the set of rules may be applied by business logic engine 210.

Method 500 may further include querying the data repository for historical data associated with the end user based on the determined identity of the end user, the historical data being data captured within a predetermined time window prior to a capture time of data in the one or more raw data streams, as illustrated in step 510. The querying may be done by customer facing services 212 which may be running on server 120. Furthermore, method 500 may also include calculating a propensity score of the end user based on the received historical data, as illustrated in step 512, and ranking the correlated data based on the propensity score, as illustrated in step 514. Moreover, method 500 may further include outputting a notification to an end user device, the notification including one or more incentives based on the correlated data ranking, as illustrated in step 516.

Although not illustrated in FIG. 5, method 500 may further include basing a quantity and type of the one or more incentives on the correlated data ranking. As previously noted, data repository may be a cloud based data lake that is configured to ingest data in real time from a plurality of sources including the end user device, store the data, and make the data available for consumption to one or more data stream consumer applications.

According to some aspects, method 500 may further include transmitting the filtered data to the data lake for storage as historical data. Moreover, the contextual filtering parameters define one or more of financial data, data unique to a service, consumer data, customer data, and geolocation data.

According to some aspects, the outputting includes querying a partnership association repository including the one or more incentives, the one or more incentives being offered by a partnering organization of an organization transmitting the notification in response to receiving the filtered data. The querying may also include extracting at least one incentive of the one or more incentives, the at least one incentive having a correlated data ranking above a predetermined threshold. Accordingly, the one or more incentives may include card offerings, digital coupons, or consumer rewards. According to some aspects, the propensity score may be continuously adjusted based on newly received historical data and correlated data. According to some embodiments, user interaction with presented offers may also be used in the determination of the propensity score. For example, user interaction with an offer such as redemption of the offer, rejection of the offer, frequency of redemption (how many offers presented to the user before the user redeems an offer), and the like, may all be used to determine and adjust the propensity score. According to some embodiments, customer facing services 212 may receive the user interaction data and forward it to data lake 202 for storage.

According to some embodiments, method 500 may further include adjusting the propensity score based on a detected change in a bank account associated with the end user. Method 500 may also include revising the notification based on the adjusted propensity score, and outputting the revised notification to the end user device.

According to some embodiments, method 500 may further include assigning higher statistical weights to historical data that occurred at a time closer to a time the query is transmitted to the data repository than statistical weights assigned to historical data that occurred at a time further to a time the query is transmitted to the data repository.

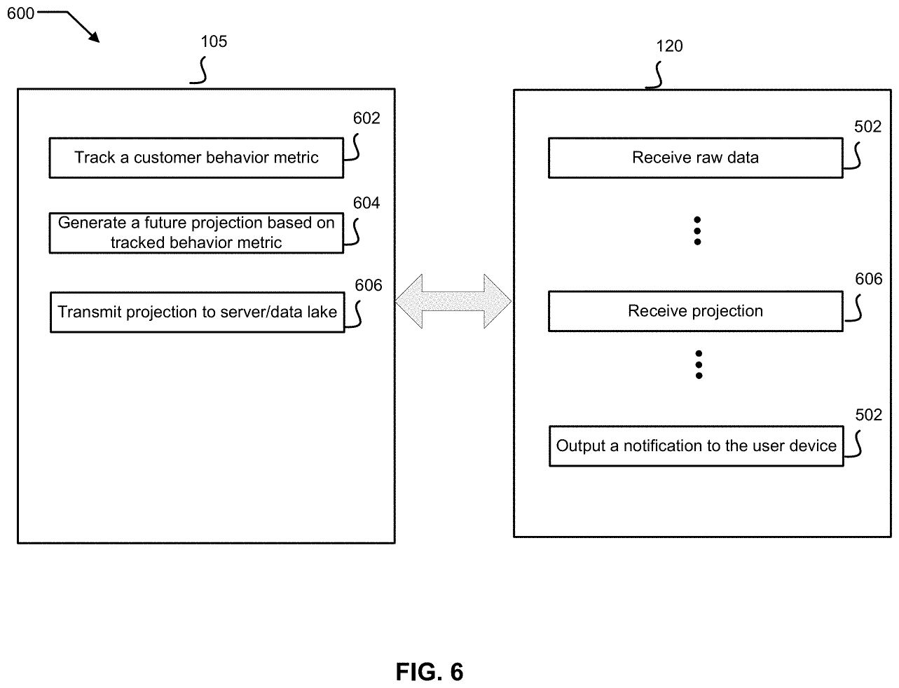

FIG. 6 is a flowchart representing an event processing method 600 that utilizes parallel processing between client device (e.g., client 105 or client 214) and server (e.g., server 120). According to some aspects, method 600 utilizes parallel processing to expedite retrieval of relevant contextual information pertaining to a customer, and generation of relevant contextual rewards in real-time. As discussed herein, such processing can lead to more efficient system output by reducing the number of rewards generated in general. This also enhances customer experience by providing to the customer, not only relevant and contextual rewards that are relevant to the most recent information of the customer (e.g., location, purchase history, etc.), but also rewards that are determined to be more likely to be used by the customer.

Method 600 may include tracking a customer behavior metric for a predetermined time at step 602. This metric may relate to the customer's browsing history, GPS location, or the like. In one example, method 600 may track a customer's GPS location for a predetermined period to provide a projection of where the customer may be headed. Similarly, method 600 may track the browsing history of the customer to determine a customer behavior profile and enable further predictions. For example, the browsing history may be browsing of websites, and/or browsing applications. If, for example, it is determined that a customer may spend a significant amount of time on a particular type of application (e.g., social media related application), then that may be factored into the types of rewards received by the customer.

According to some aspects, at step 604 method 600 may further generate a future projection based on the tracking of step 602. In one example, the projection may include projecting where, within a commercial area, the customer may be headed (e.g., what store or nearest stores), or project which commercial area the customer may be headed to, or the like. Method 600 further includes parallel processing being performed on the server side (e.g., at server 120). In one example, method 600 may include generating a user profile by aggregating user related data, such as, for example historical data, at step 604. Collecting historical data may done using data stream consumers of data from data lake 202 and the like.

Method 600 may further include sending from client 105 and receiving at server 120, processed information of client device 105 (step 606). This may be, but is not limited to, the GPS data and GPS projections associated with user movement. According to some aspects, server 120 may utilize the projections, to generate an incentive/reward to the user. The reward may take into consideration aspects discussed in FIG. 5. For example, the reward may take into consideration associating the processed information from client device 105 along with historical data, and additional correlated data (e.g., step 508) to generate an output that is then filtered for propensity scoring.

Descriptions to an embodiment contemplate various combinations, components and sub-components. However, it will be understood that other combinations of the components and sub-components may be possible while still accomplishing the various aims of the present application. As such, the described embodiments are merely examples, of which there may be additional examples falling within the same scope of the disclosure.

What is claimed is:

1. A communication method for transmitting notifications to an end user from a server, the method being performed on one or more processing devices, the method comprising:
receiving, from a data repository, one or more raw data streams of real time data in response to a query transmitted to the data repository from a data stream consumer application running on the server, the query requesting predetermined real-time data associated with the end user;
determining an identity of the end user based on the one or more raw data streams;
filtering, using contextual filtering parameters, the received one or more raw data streams to produce filtered data;
applying a set of rules correlating the filtered data with incentive programs relevant to the filtered data to generate correlated data;
querying the data repository for historical data associated with the end user based on the determined identity of the end user, the historical data being data captured within a predetermined time window prior to a capture time of data in the one or more raw data streams;
calculating a propensity score of the end user based on the received historical data;
ranking the correlated data based on the propensity score; and
sending a notification to an end user device, the notification including one or more incentives based on the correlated data ranking.

2. The communication method according to claim 1, wherein a quantity and type of the one or more incentives is based on the correlated data ranking.

3. The communication method according to claim 1, wherein the data repository is a cloud based data lake configured to
ingest data in real time from a plurality of sources including the end user device,
store the data, and
make the data available for consumption to one or more data stream consumer applications.

4. The communication method according to claim 3, further comprising:
transmitting the filtered data to the data lake for storage as historical data.

5. The communication method according to claim 1, wherein the contextual filtering parameters define one or more of financial data, data unique to a service, consumer data, customer data, and geolocation data.

6. The communication method according to claim 1, the outputting further comprising:
querying a partnership association repository including the one or more incentives, the one or more incentives being offered by a partnering organization of an organization transmitting the notification in response to receiving the filtered data; and
extracting at least one incentive of the one or more incentives, the at least one incentive having a correlated data ranking above a predetermined threshold.

7. The communication method according to claim 6, wherein the one or more incentives include card offerings, digital coupons, or consumer rewards.

8. The communication method according to claim 1, wherein the propensity score is continuously adjusted based on newly received historical data and correlated data.

9. The communication method according to claim 1, further comprising:
adjusting the propensity score based on a detected change in a bank account associated with the end user;
revising the notification based on the adjusted propensity score; and
outputting the revised notification to the end user device.

10. The communication method according to claim 1, further comprising:
assigning higher statistical weights to historical data that occurred at a time closer to a time the query is transmitted to the data repository than statistical weights assigned to historical data that occurred at a time further to a time the query is transmitted to the data repository.

11. A system comprising:
a memory configured to store operations; and
one or more processing devices configured to process the operations, the operations comprising:
receiving, from a data repository, one or more raw data streams of real time data in response to a query transmitted to the data repository from a data stream consumer application running on a server, the query requesting predetermined real-time data associated with an end user,
determining an identity of the end user based on the one or more raw data streams,
filtering, using contextual filtering parameters, the received one or more raw data streams to produce filtered data,
applying a set of rules correlating the filtered one or more raw data streams with incentive programs relevant to the filtered data to generate correlated data,
querying the data repository for historical data associated with the end user based on the determined identity of the end user, the historical data being data captured within a predetermined time window prior to a capture time of data in the one or more raw data streams,
calculating a propensity score of the end user based on the received historical data,
ranking the correlated data based on the propensity score, and
sending a notification to an end user device, the notification including one or more incentives based on the correlated data ranking.

12. The system according to claim 11, wherein a quantity and type of the one or more incentives is based on the correlated data ranking.

13. The system according to claim 11, wherein the data repository is a cloud based data lake configured to
ingest data in real time from a plurality of sources including the end user device,
store the data, and
make the data available for consumption to one or more data stream consumer applications.

14. The system according to claim 13, wherein the operations further comprise:
transmitting the filtered data to the data lake for storage as historical data.

15. The system according to claim 11, wherein the contextual filtering parameters define one or more of financial data, data unique to a service, consumer data, customer data, and geolocation data.

16. The system according to claim 15, the outputting operation further comprising:
querying a partnership association repository including the one or more incentives, the one or more incentives being offered by a partnering organization of an organization transmitting the notification in response to receiving the filtered data, and
extracting at least one incentive of the one or more incentives, the at least one incentive having a correlated data ranking above a predetermined threshold.

17. The system according to claim 11, wherein the propensity score is continuously adjusted based on newly received historical data and correlated data.

18. The system according to claim 11, the operations further comprising:
adjusting the propensity score based on a detected change in a bank account associated with the end user,
revising the notification based on the adjusted propensity score, and
sending the revised notification to the end user device.

19. The communication method according to claim 11, the operations further comprising:
assigning higher statistical weights to historical data that occurred at a time closer to a time the query is transmitted to the data repository than statistical weights assigned to historical data that occurred at a time further to a time the query is transmitted to the data repository.

20. A non-transitory computer-readable medium storing instructions that when executed by one or more processors of a server transmitting notifications to an end user, cause the one or more processors to:
receive, from a data repository, one or more raw data streams of real time data in response to a query transmitted to the data repository from a data stream consumer application running on the server, the query requesting predetermined real-time data associated with the end user,
determine an identity of the end user based on the one or more raw data streams,
filter, using contextual filtering parameters, the received one or more raw data streams to produce filtered data,
apply a set of rules correlating the filtered one or more raw data streams with incentive programs relevant to the filtered data to generate correlated data,
query the data repository for historical data associated with the end user based on the determined identity of the end user, the historical data being data captured within a predetermined time window prior to a capture time of data in the one or more raw data streams,
calculate a propensity score of the end user based on the received historical data,
rank the correlated data based on the propensity score, and
send a notification to an end user device, the notification including one or more incentives based on the correlated data ranking.
